(19) United States
(12) Patent Application Publication
(10) Pub. No.: US 2005/0055832 A1
(43) Pub. Date: Mar. 17, 2005

(54) Hand-guidable tool with handle heating based on microwaves

(76) Inventor: Wolfgang Jaensch, Tremsbuettel (DE)

Correspondence Address: Marlana Titus;Nash & Titus, LLC, 6005 Riggs Road, Laytonsville, MD, 20882, US

(21) Appl. No.: 10/860,675

(22) Filed: Jun. 3, 2004

(30) Foreign Application Priority Data
Jun. 4, 2003 (DE) DE203 08 674.0

(51) Int. Cl. B27B 17/00; B23D 57/02

(52) U.S. Cl. 30/123; 30/381; 83/830; 83/821

(57) ABSTRACT

The invention entails an actuatable tool, such as a chain saw, with at least one handle for manually manipulating the tool by one hand of a user. The tool includes at least one device in at least one area of the at least one handle. The device is suitable and adapted for radiating energy in the form of electromagnetic radiation in the microwave range so that a warming of the user's hand can be brought about.

### BACKGROUND OF THE INVENTION

The present invention is relative to a hand-guidable, activatable or crankable tool with at least one heatable handle. In particular, the present invention is relative to a tool with a handle heating based on microwave technology.

According to the state of the art, numerous methods are known that are suitable for heating the handles of hand-guidable, activatable tools used with preference for working outdoors such as, e.g., chain saws.

A user is particularly exposed to weather conditions when working with hand-guidable, activatable tools outdoors. In particular, low temperatures below 10° C. are a problem as they are perceived to be especially unpleasant by the hands of the user. Protective gloves are suited for minimizing the heat loss. The insulating action of the gloves is also limited on account of a limitation of their thickness, depending on the requirements on the sensitive or fine motor response to be applied by the operating person. Furthermore, the cooperation of a cool handle with vibrations imparted through the tool to the hands not only produces limitations on the motor response but also a pathological action of the fingers of the user is observed. Therefore, suitable, heated handles were developed for such hand-guidable, activatable tools used in particular outdoors.

Thus, methods are known for, among other things, heating handles of motor-driven hand tools, especially motor saws, whose hollow handles are provided with inlet and outlet openings so that at least a volumetric part of the exhaust gases of a driving internal combustion engine is conducted through the handles that result in a warming of the handles during the operation of the hand tool. In a similar manner, e.g., utility model DE 299 14 164 U1 discloses a motor-driven hand tool whose hollow handles are provided with inlet and outlet openings so that a volumetric part of a flow of cooling liquid of a driving motor can be conducted through the handles that results in a warming of the handles during the operation of the hand tool. Regulating of the warming of the handles that takes place by exhaust gases or a current of cooling liquid takes place by means of suitably arranged valves that make it possible to regulate the volumetric flow of the exhaust gases or of the current of cooling liquid.

Likewise, e.g., utility model DE 202 09 522.3 discloses a hand-guided, activatable tool, in particular a chain saw, with a handle comprising a connection to a permanent heat storage circuit. The circuit is designed along the handle for the emission of heat and in the area of the drive for the receiving of heat. Furthermore, the permanent heat storage circuit is operated by a permanent heat storage based on crystallization heat.

Likewise, hand-guided, activatable tools are known whose handles are equipped with an electric handle heating. In particular, resistance foils placed on the handles are used for an electric heating of handles.

The known methods for heating handles and/or the correspondingly designed tools have the feature in common that tool handles are heated that for their part act in a warming manner on the hands of a user. If the user is wearing gloves, which is necessary for most hand-guidable, activatable tools when used outdoors for safety reasons, the warming action of the heated handles takes effect with a delay since the thermal energy made available by the heated handles must first warm the gloves themselves before the hands of the user that are located in the gloves warm up. This implies, depending on the insulating property of the gloves, a significant delay of the warming action on the user's hands. Furthermore, the regulating properties of the heating capacity are not optimal on account of the delay of the warming action on the hands.

### SUMMARY OF THE INVENTION

The present invention addresses the problem of making available a hand-guidable, activatable tool with at least one handle that comprises a heat source that acts in a directly warming manner on the hands of a user and does not imply the above-described disadvantages of the handle heatings of the state of the art.

The problem is solved with a generic tool with the features characterized as including an actuatable tool, especially a chain saw, with at least one handle for manually manipulating the tool by one hand of a user, wherein at least one device is provided in at least one area of the at least one handle which device is suitable and adapted for radiating energy in the form of electromagnetic radiation in the microwave range so that a warming of the user's hand can be brought about. Advantageous embodiments are defined below.

The invention provides that the activatable tool, that is, a work machine or a hand tool and especially a chain saw, is provided with at least one handle for manually managing the tool with one hand of a user in at least one area of the at least one handle with at least one device adapted to radiate energy in the form of electromagnetic radiation in the microwave range so that a warming of the user's hand occurs when it is located in the effective range of the electromagnetic radiation. To this end at least a part of the radiated electromagnetic radiation energy, whose frequency is in the microwave range, is absorbed by the tissue of the hand and converted into thermal energy.

### BRIEF DESCRIPTION OF THE FIGURES

FIG. 1 shows a schematic view of an embodiment of a hand-guidable, activatable tool of the present invention.

FIG. 2 shows a schematic view of a generator in accordance with an embodiment of a hand-guidable, activatable tool of the present invention.

FIG. 3 shows a schematic view of a first handle according to an embodiment of the present invention.

FIG. 4 shows a schematic view of a second handle according to an embodiment of the present invention.

### DETAILED DESCRIPTION

According to an embodiment of the invention the tool comprises an internal combustion engine as drive motor to which a generator for producing electric power or electric current is coupled in a suitable manner.

According to an embodiment of the invention the at least one device comprises a microwave generator that is capable of generating electromagnetic radiation energy in the range of microwave radiation.

According to an embodiment of the invention the at least one microwave generator is arranged in the at least one handle in an integrated manner.

According to an embodiment of the invention the electromagnetic radiation energy is conducted by one or several waveguides or hollow conductors (or waveguide) for electromagnetic radiation. The waveguides or hollow conductors are coupled to this end in a suitable manner to the at least one microwave generator and designed in such a manner that the one or the several electromagnetic waveguides decouple(s) the conducted electromagnetic radiation energy in the at least one area of the at least one handle.

According to an embodiment of the invention the tool comprises two handles for manual manipulation. At least one microwave generator is arranged in an integrated manner in each of the two handles in order to generate the electromagnetic radiation energy.

According to an embodiment of the invention two microwave generators are integrated in one of the two handles whereas one microwave generator is integrated in the other one of the two handles. Furthermore, the microwave generators are arranged at positions that are preferably assumed by the hands of the user for manually guiding the tool.

According to an embodiment of the invention the tool comprises at least one control device adapted in such a manner as to regulate the electromagnetic radiation energy.

According to an embodiment of the invention the tool comprises a sensor for detecting a measured temperature value by means of which measured value the radiated energy can be regulated.

According to an embodiment of the invention the tool comprises a manually operable adjusting device that generates a regulating value with which the radiated energy can be regulated.

The invention is described in detail below with reference made to the attached drawings.

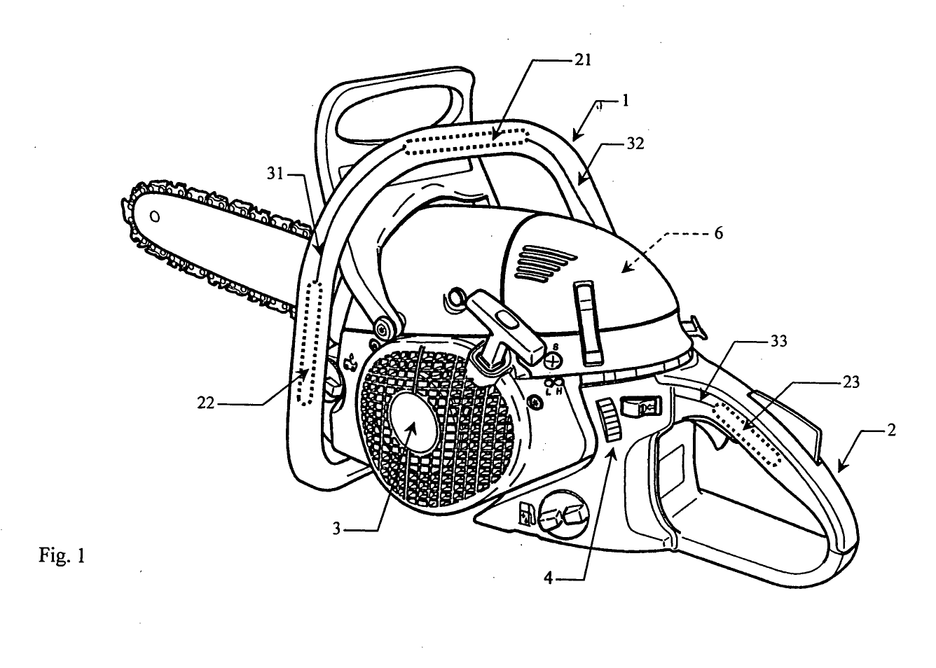

The invention is described using the hand-guidable, activatable tool in the form of a chain saw and shown in FIGS. 1 to 4 with an internal combustion engine and components of it presented solely by way of example. The invention can also be used in other tools such as, e.g., abrasive cutting-off machines, hedge shears, hammer drills, chisel tools, etc. Similar or identical components are designated with the same reference numerals.

FIG. 1 shows a schematic view of a generic chain saw as example for a hand-guidable, activatable tool. The chain saw comprises a first handle 1 and a second handle 2 with the aid of which the chain saw user handles it. The chain saw shown is driven by internal combustion engine 3 that comprises a generator for generating electric power.

As regards the problem of the invention, the chain saw also comprises adjusting device 4, integrated control device 6 or integrated control electric circuitry, first, second and third microwave generators 21, 22, 23 as well as current feed lines 31, 32, 33 to the corresponding microwave generators 21, 22, 23. Integrated control device 6 is supplied with current (or power) by the generator coupled to internal combustion engine 3. For its part, control device 6 supplies microwave generators 21, 22, 23 with current (or power) and controls the feeding of current (or power) to microwave generators 21, 22, 23.

Adjusting device 4 can be operated by the chain saw user and is adapted to generate a control signal corresponding to a power regulating value with which the power [performance] of microwave generators 21, 22, 23 is selected. The control signal of adjusting device 4 is supplied to integrated control device 6 that controls or regulates the individual microwave generators. Adjusting device 4 is also suitable for generating a switching signal that serves to turn the microwave generators on or off.

Integrated control device 6 is preferably designed as an electric circuit or as electronic control circuitry. Furthermore, one or several temperature signals can be supplied from temperature sensors (not shown) to integrated control device 6 which sensors detect an outside (or external, ambient) temperature and/or temperatures in the area of one or more hand positions on one or more handles. These temperature signals act with the previously described regulating value signal on the regulating of integrated control device 6. A suitable electrically or electronically designed control-or regulating algorithm brings about the power regulation of the microwave generators.

A microwave generator is based substantially on a power transformer that generates a high-voltage signal supplied to a magnetron capable of generating electromagnetic radiation in the microwave range by means of the high-voltage signal. The high-voltage signal is preferably a direct voltage signal. When the magnetron is supplied with alternating voltage it is to be provided with a rectifier with possibly suitable capacitive smoothing.

A hollow conductor can be coupled to the magnetron in order to conduct the generated electromagnetic radiation to a predetermined location. The frequency of the electromagnetic microwave radiation is selected so that when the radiation enters into water-containing substances, especially into body tissue, a vibrational excitation of the water molecules takes place which results in an elevation of the temperature of the substance and/or of the body tissue. This effect of electromagnetic microwave radiation is also used, e.g., in medicine for heat treatment. The microwave generators used in the present invention are based on this technology.

Care is to be taken that the power capacity of microwave generators 21, 22, 23 used in the present invention is adapted in such a manner that no damaging effects are produced on the body of the user of the chain saw or tool. Since microwave technology is also used in various medical fields, medical limit values are available for such microwave generators that assure, when observed, that no damage occurs in tissues of bodies irradiated with microwaves.

Microwave generators 21, 22, 23 are arranged in the handle in such a manner that, in particular, hands located at typical holding positions of the handles are warmed. To this end at least one microwave generator per handle can be used. The arrangement of the microwave generators used in the handles and the handle design are preferably selected so that a radial, substantially uniform radiation field is formed at least in the area of the hand positions of the used in order that a substantially constant radiation power is volumetrically (or radially, present over the area) present. Due to the reflective action of metals on microwaves, care is to be taken when designing the handles that either no metal material is used or that at least precautions that make possible a passage of microwave radiation in a suitable manner are taken when using metallic materials.

In FIG. 1 the two microwave generators 21, 22 are arranged in the first handle 1. Microwave generators 21, 22 are arranged in preferred handle positions (above and laterally) that are used by a user of the tool when handling it. Microwave generators 21, 22 radiate the microwave radiation generated by them in a radial direction so that a substantially volumetrically uniform microwave radiation field is present in the associated partial areas of handle 1 that warms a hand located in the radiation field. Current feed lines 32, 31 feed associated microwave generators 21, 22 with an appropriate power or make an appropriate power control signal available to microwave generators 21, 22.

In an analogous manner microwave generator 23 is arranged in second handle 2 in a preferred handle position used by a user of the tool when handling it. Microwave generator 23 radiates the microwave radiation generated by it in a radial direction so that a substantially volumetrically uniform microwave radiation field is present in the associated partial area of handle 1 that warms a hand located in the radiation field. Current feed line 33 feeds associated microwave generators 23 with an appropriate power or make an appropriate power control signal available to microwave generator 23.

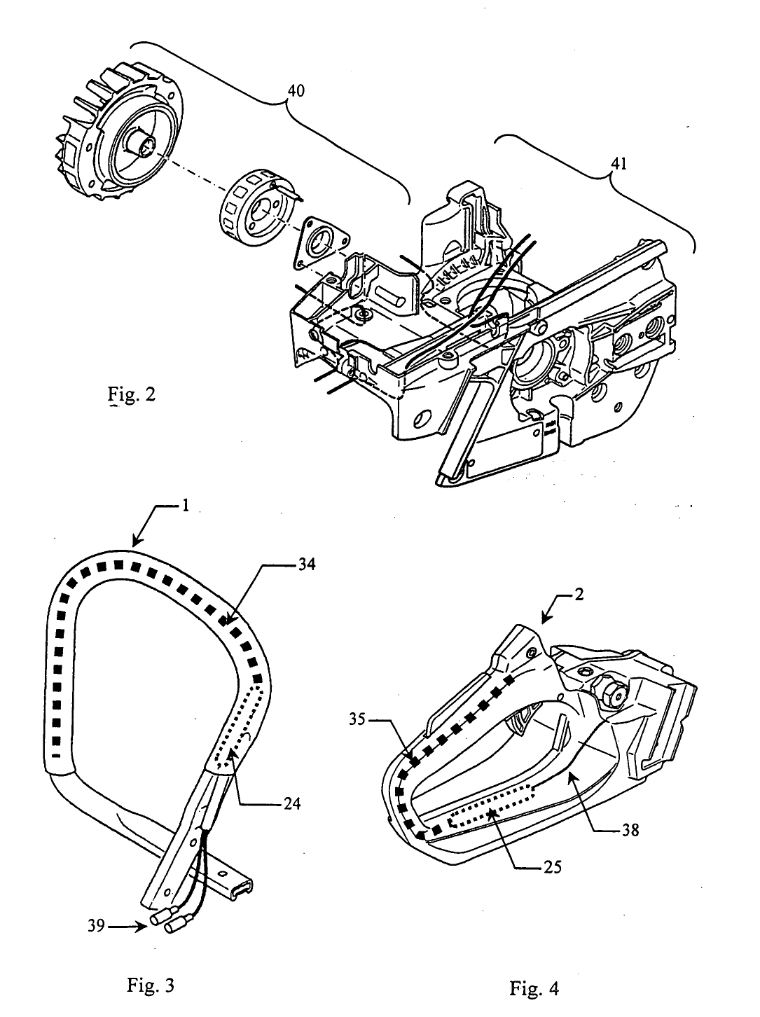

FIG. 2 shows a magnet wheel (or field spider) generator coupled to the internal combustion engine of the chain saw according to FIG. 1. Magnet wheel generator 40 is coupled to the drive shaft of the internal combustion engine (not shown). Magnet wheel generator 40 is received by the shown housing part of the internal combustion engine. In particular, FIG. 2 shows a magnet wheel generator 40 composed of a magnet wheel and a generator armature and fastened by a generator carrier. Magnet wheel generator 40 is received in crankcase 41 of the internal combustion engine. The generator windings are housed in the generator armature.

Magnet wheel generator 40 can be designed as a direct-voltage or alternating-voltage generator. As previously described, microwave generators are preferably operated with a direct voltage signal so that in the case of an alternating-voltage generator one or more suitable rectifiers are to be used.

FIG. 3 shows an alternative arrangement of a microwave generator in a first handle. Microwave generator 24 is arranged in a first position in the area of an end of first handle 1 and is supplied with current or power by means of current sockets (or jacks) 39. The power supply takes place regulated with the aid of integrated control device 6. Hollow conductor 34 is coupled to microwave generator 24 and designed in such a manner that the microwave radiation generated and supplied by the microwave generator is radiated over the entire extent of hollow conductor 34 vertically (radially) to its direction of extension so that a microwave radiation field is present around the area of handle 1 which area is associated with hollow conductor 34. The radiation field is advantageously constant over the entire handle range defined by hollow conductor 34. Alternatively, e.g., a radiation field can be present in the area of the previously described handle positions (corresponding to the positions of microwave generators 21, 22). Hollow conductor 34 can be provided, e.g., with suitably arranged recesses that make possible a passage of part of the microwave radiation conducted in hollow conductor 34 so that a radiation of microwaves along hollow conductor 34 results.

FIG. 4 shows an alternative arrangement of a microwave generator in a second handle. Microwave generator 25 is arranged in a first position in the area of an end of first handle 2 and is supplied with current or power by current feed line 38. The power supply takes place in a regulated manner by integrated control device 6. Hollow conductor 35 is coupled to microwave generator 25 and designed in such a manner that the microwave radiation generated and supplied by the microwave generator is radiated over the entire extent of hollow conductor 35 vertically (radially) to its direction of extension so that a microwave radiation field is present around the area of handle 2 which area is associated with hollow conductor 35. The radiation field is advantageously constant over the entire handle range defined by hollow conductor 35. Alternatively, e.g., a radiation field can be present in the area of the previously described handle positions (corresponding to the position of microwave generator 23). Hollow conductor 35 can be provided, e.g., with suitably arranged recesses that make possible a passage of part of the microwave radiation conducted in hollow conductor 35 so that a radiation of microwaves along hollow conductor 35 results.

Analogously to FIGS. 3, 4 in which a microwave generator 24, 25 is present per handle 1 and 2, e.g., a centrally arranged microwave generator can be used as an alternative. This microwave generator would furthermore be provided, e.g., with two hollow conductors that couple in the microwave radiation generated by the microwave generator and conduct it to handles 1 and 2, in which instance the two hollow conductors in the area of the handles are designed in such a manner that a decoupling (or coupling out) of the microwave radiation takes place so that a suitably formed radiation field is present in the area of the handles or in partial areas of the handles in order to warm the hands of a user in a previously described manner.

It should be noted that the handle heating was presented based on microwave generators using the example of a tool that can be driven by an internal combustion engine, in particular based on a chain saw. However, the invention is limited neither to a chain saw nor to a tool that can be driven by an internal combustion engine. The handle heating based on microwave generators can also be used in a current-driven tool such as, e.g., an electric saw, electric hedge shears, etc.

List of reference numerals:

1 first handle
2 second handle
3 drive motor
4 adjusting device
6 integrated control device (electronic circuitry)
21 first microwave generator
22 second microwave generator
23 third microwave generator
24 fourth microwave generator
25 fifth microwave generator
31 current feed line
32 current feed line
33 current feed line
34 hollow conductor (waveguide)
35 hollow conductor (waveguide)
40 magnet wheel generator
41 crankcase

1-10. (Previously canceled without prejudice or disclaimer)

11. An actuatable tool with at least one handle for manually handling the tool via a user's hand, in which a device is provided in at least one area of the at least one handle, which device is suitable and adapted for radiating energy in the form of electromagnetic radiation in the microwave range so that the user's hand can be warmed, and in which the at least one device comprises at least one microwave generator adapted so as to generate electromagnetic radiation energy.

12. The tool according to claim 11, wherein the tool is a chain saw.

13. The tool according to claim 11, comprising an internal combustion engine as a drive motor to which a generator for generating electric power is coupled in a suitable manner.

14. The tool according to claim 11 in which the at least one microwave generator is arranged in the at least one handle.

15. The tool according to claim 11, in which the at least one device also comprises one or more waveguides that are coupled to the at least one microwave generator and can conduct the electromagnetic radiation energy, and in which the one or several waveguides are designed in such a manner that the conducted electromagnetic radiation energy can be decoupled in at least one area of the at least one handle.

16. The tool according to claim 11, comprising two handles for manual handling in which the two handles are provided and at least one microwave generator is arranged in each of the two handles which is adapted so as to be able to generate the electromagnetic radiation energy.

17. The tool according to claim 16, in which two microwave generators are provided in one of the two handles and one microwave generator is provided in the second handle and in which the microwave generators are arranged at positions that are preferably assumed by the hands of the user for manually guiding the tool.

18. The tool according to claim 11, which tool comprises at least one control device adapted in such a manner as to regulate the electromagnetic radiation energy.

19. The tool according to claim 11, which tool comprises at least one sensor for detecting a measured temperature value by means of which measured value the radiated energy can be regulated.

20. The tool according to claim 11, which tool comprises a manually operatable adjusting device that generates a regulating value with which the radiated energy can be regulated.
